(19) United States
(12) Patent Application Publication
(10) Pub. No.: US 2014/0014049 A1
(43) Pub. Date: Jan. 16, 2014

(54) SYSTEM AND METHOD OF IMPROVING FUEL EFFICIENCY IN VEHICLES USING HHO

(71) Applicant: The Hydrogen Group, Inc., Winter Springs, FL (US)

(72) Inventors: Timothy Allen Watson, Bronson, FL (US); James Edward Lowe, Williston, FL (US); Armand Rene Dauplaise, Winter Springs, FL (US)

(21) Appl. No.: 13/940,978

(22) Filed: Jul. 12, 2013

Related U.S. Application Data
(60) Provisional application No. 61/671,404, filed on Jul. 13, 2012.

(51) Int. Cl. F02B 43/00

(52) U.S. Cl. CPC F02B 43/00
USPC 123/3

(57) ABSTRACT

A system and method of providing HHO gas to an internal combustion engine in a vehicle involves providing a liquid electrolyte solution to an HHO generator configured to produce and output HHO gas therefrom, separating residual electrolyte solution from the HHO gas output by the HHO generator, storing a quantity of the HHO gas in a pressure tank at a pressure level exceeding an ambient atmospheric pressure, and regulating a rate at which the HHO gas from the pressure tank flows to the internal combustion engine with a carburetor device.

### CROSS-REFERENCE TO RELATED APPLICATION(S)

This application claims the benefit of U.S. Provisional Application No. 61/671,404 filed Jul. 13, 2012 for “SYSTEM AND METHOD OF IMPROVING FUEL EFFICIENCY IN VEHICLES USING HHO” by T. Watson, J. Lowe and A. Dauplaise.

### INCORPORATION BY REFERENCE

The aforementioned U.S. Provisional Application No. 61/671,404 is hereby incorporated by reference in its entirety.

### BACKGROUND

The present invention relates to a system that produces an HHO mix of fuel in vehicles that reduces exhaust emission and increases fuel efficiency.

There has been a continuing effort to improve the fuel efficiency of vehicles, in order to reduce fuel costs and/or emissions among other concerns. One concept that has been presented for improving fuel efficiency in vehicles employing gasoline-powered engines is to provide HHO (a gas consisting of two atoms of hydrogen and one atom of oxygen) to the engine. This concept has been believed to have the potential to increase fuel efficiency by causing the gasoline in the combustion chamber of the engine to burn more completely. However, the actual results of systems of this type have shown small or no improvement in fuel efficiency.

There is a continuing need for a system and method of improving fuel efficiency in vehicles. Such a system and method is the subject of the present invention.

### SUMMARY

A system for providing HHO gas to an internal combustion engine in a vehicle includes a power supply and an HHO generator, powered by the power supply, that includes at least one HHO generating structure, arranged to receive a liquid electrolyte solution and output HHO gas. A liquid solution container module is coupled to the HHO generator, configured to hold and pump the liquid electrolyte solution and to separate the HHO gas from residual liquid electrolyte solution output from the HHO generator. A dryer is coupled to receive the HHO gas from the liquid solution container and gas separation module to remove moisture and/or particles in the HHO gas. A pressure tank is coupled to receive the HHO gas from the dryer and store a quantity of the HHO gas at a pressure level exceeding an ambient atmospheric pressure. A carburetor device is coupled to the pressure tank, the carburetor device being operable to regulate a rate at which the HHO gas from the pressure tank flows to the internal combustion engine.

A method of providing HHO gas to an internal combustion engine in a vehicle involves providing a liquid electrolyte solution to an HHO generator configured to produce and output HHO gas therefrom, separating residual electrolyte solution from the HHO gas output by the HHO generator, storing a quantity of the HHO gas in a pressure tank at a pressure level exceeding an ambient atmospheric pressure, and regulating a rate at which the HHO gas from the pressure tank flows to the internal combustion engine with a carburetor device.

### BRIEF DESCRIPTION OF THE DRAWINGS

FIG. 1A is a schematic block diagram, and FIG. 1B is a pictorial diagram, of a system that produces an HHO mix of fuel in vehicles that reduces exhaust emission and increases fuel efficiency according to an embodiment of the present invention.

FIGS. 2, 3 and 4 are photographs of a prototype of a system that produces an HHO mix of fuel in vehicles that reduces exhaust emission and increases fuel efficiency, installed on a vehicle according to an embodiment of the present invention.

FIG. 5A is an exploded view, FIG. 5B is an inlet side view, and FIG. 5C is an outlet side view, of an HHO generator for use in the system shown in FIGS. 1A and 1B according to an embodiment of the present invention.

FIG. 6 is a diagram of a carburetor device for use in the system shown in FIGS. 1A and 1B according to an embodiment of the present invention.

FIGS. 7, 8, 9 and 10 are photographs of a prototype of a system as shown in FIGS. 1A and 1B employing an HHO generator as shown in FIGS. 5A-5C and a carburetor device as shown in FIG. 6.

### DETAILED DESCRIPTION

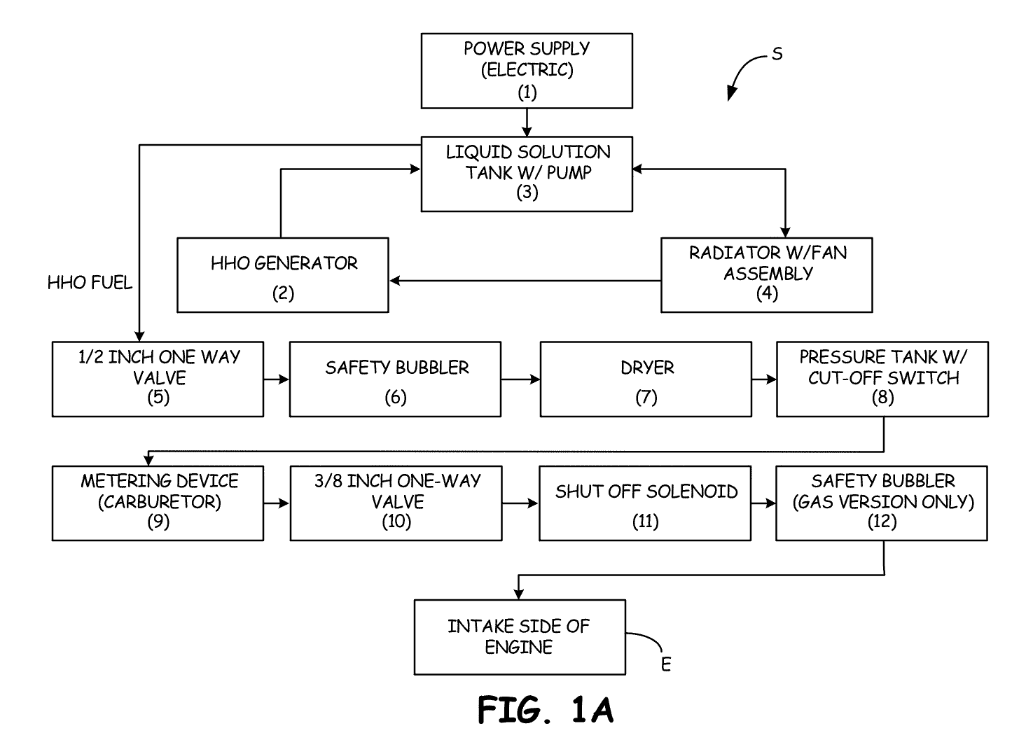

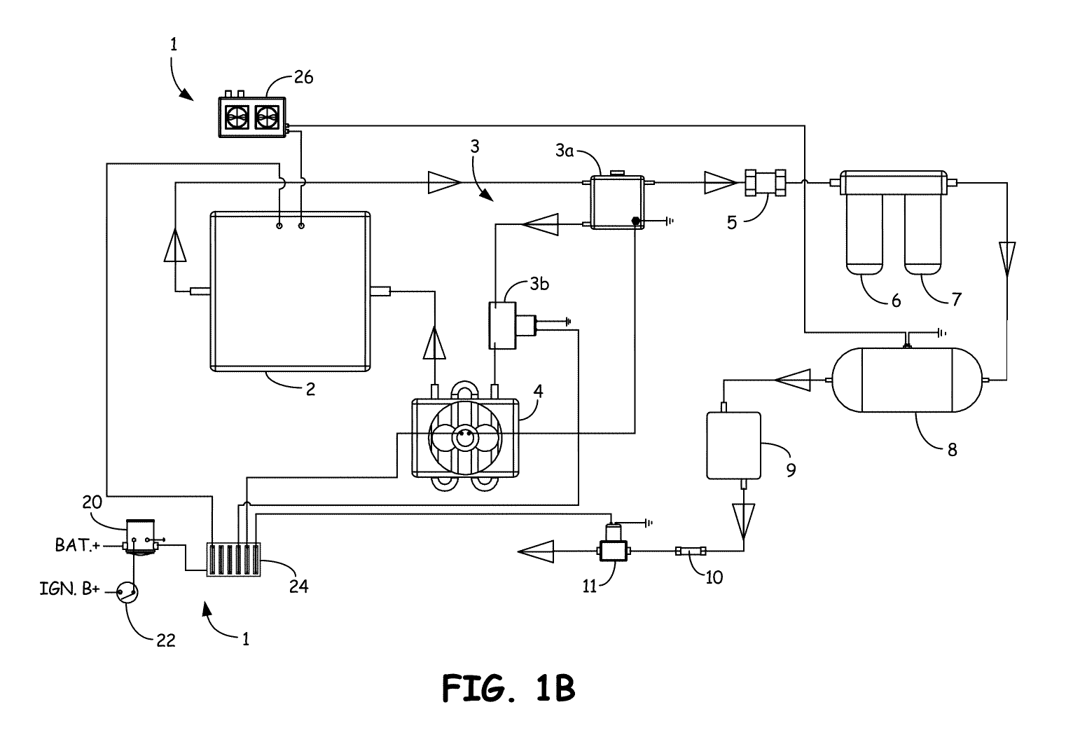

FIG. 1A is a schematic block diagram, and FIG. 1B is a pictorial diagram, of system S that produces an HHO mix of fuel in vehicles that reduces exhaust emission and increases fuel efficiency according to an embodiment of the present invention. As shown in FIG. 1A, the system includes power supply 1, HHO generator 2, liquid solution container and pump module 3, radiator/fan assembly 4, one-way valve 5, safety bubbler 6, dryer 7, pressure tank 8 with a cut-off switch, metering carburetor device 9, one-way valve 10, shut-off solenoid 11, and safety bubbler 12 (included only for gasoline-power engines—not included for diesel-powered engines). As shown in FIG. 1B, power supply 1 in an exemplary embodiment includes battery/solenoid 20 connected to on/off switch 22, fuse block 24, and pulse-width regulator 26. As also shown in FIG. 1B, liquid solution container and pump module 3 in an exemplary embodiment includes liquid solution tank and gas separator module 3a and liquid solution tank with pump module 3b connected to one another.

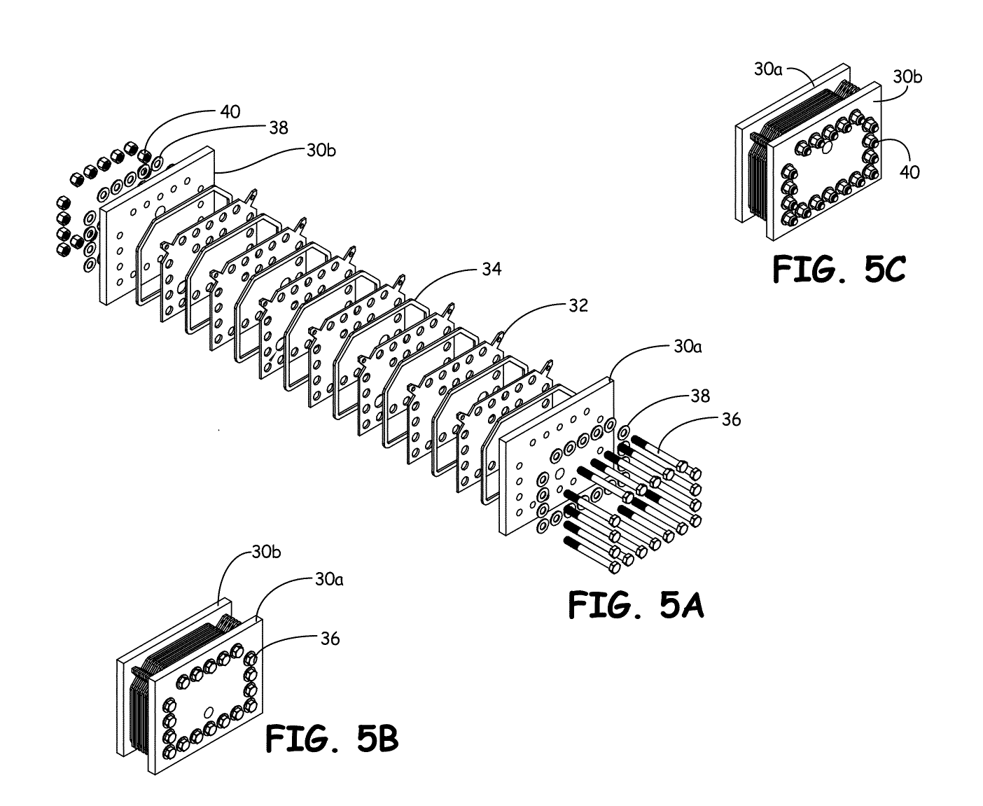

In operation, power is supplied to HHO generator 2 and liquid solution container and pump module 3 by power supply 1, which in an exemplary embodiment is an electric power supply. Power supply 1 includes pulse width regulator 26 in an exemplary embodiment, to control the power provided to HHO generator 2 similar to the control of an electric motor. HHO generator 2 is a dry-cell device in an exemplary embodiment, and is shown and described in more detail below with respect to FIG. 5.

Liquid electrolyte solution, such as a solution of 75% water and 25% potassium hydroxide (KOH) by volume in an exemplary embodiment, flows from liquid solution tank and gas separator module 3a to liquid solution tank with pump module 3b, and is pumped through radiator/fan assembly 4 (which is a heat exchanger that helps to cool the solution). In an exemplary embodiment, radiator/fan assembly 4 operates to turn on the fan and pump assembly when the liquid solution reaches 120° F., to cool the liquid solution below 95° F. The liquid solution is then pumped into HHO generator 2. HHO generator 2 is configured so that the liquid solution flows over charged core plates to break the chemical bonds of the water (H₂O) into a gas (HHO) made up of two parts hydrogen and one part oxygen. In an exemplary embodiment, the core plates are made of grade 316L stainless steel and are charged with 10 Ampere current having a power level of 120 Watts. After treatment in HHO generator 2, the gas and residual liquid solution flows back into liquid solution tank and gas separator 3a. The gaseous HHO alternative fuel is then separated from the liquid solution, such as by a filter, with the residual liquid solution settling to a lower part of the liquid solution tank and gas separate 3a while HHO gas moves upward through one-way valve 5. In an exemplary embodiment, one-way valve 5 is configured as a one-half inch gas check valve. The gas then proceeds through safety bubbler 6. One-way valve 5 and safety bubbler 6 help to prevent explosive flashback events from migrating back toward HHO generator 2. Safety bubbler 6 performs this function by bubbling the HHO mixture through a non-flammable liquid, so that flashback from any source is arrested.

One HHO gas has passed through one-way valve 5 and safety bubbler 6. It flows into dryer 7, which is configured in an exemplary embodiment as a filter that traps particles and residual vapors that are included with the HHO gas to remove any moisture (e.g., steam) or particulates that may have been included in the HHO alternative fuel that was separated from the liquid solution in liquid solution tank and gas separator 3a to produce an output of clean, dry HHO gas. The HHO gas then flows into pressure tank 8, where a small amount of pressure and a volume of gaseous fuel are accumulated, stored at a pressure that exceeds the ambient atmospheric pressure. A cut-off switch installed with pressure tank 8 automatically shuts off the flow of fuel when a pressure threshold is reached in pressure tank 8. Pressure is applied to fuel in pressure tank 8 to ensure that adequate HHO alternative fuel reserves are maintained and a steady and constant flow can be achieved.

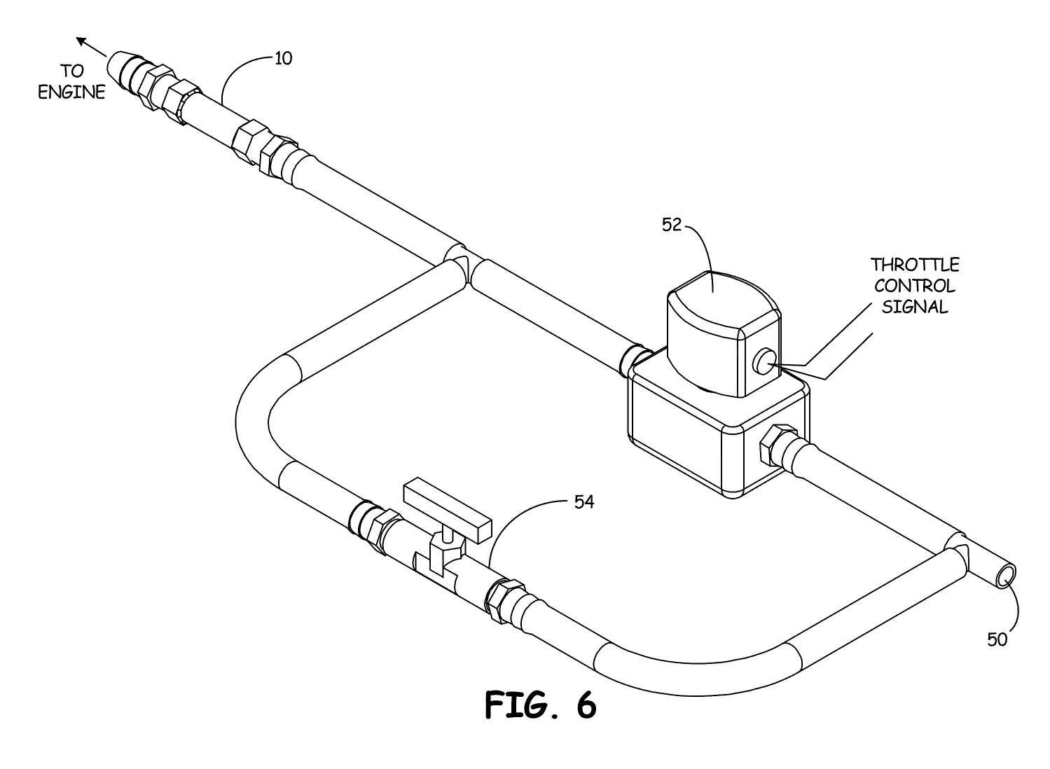

Fuel flow from pressure tank 8 is controlled by metering carburetor device 9 through one-way valve 10 to control the volume and timing of fuel flow into the intake side of engine E, similar to a fuel injector. In an exemplary embodiment, one-way valve 10 is a three-eighths inch back blast check valve. Carburetor device 9 may be implemented in exemplary embodiments with a constant velocity, slide-type orifice that regulates the rate at which pressurized HHO is fed into the intake side of the head of engine E. Carburetor device 9 may be controlled according to an algorithm that maximizes the effectiveness of the HHO alternative fuel being added to the engine, so that fuel efficiency may be improved by a substantial amount. Carburetor device 9 is shown and described in more detail below with respect to FIG. 6. Shut-off solenoid 11 automatically shuts off the flow of fuel when a key controlling engine E is turned off, and allows flow to resume then the key controlling engine E is turned on. In the manner described above, engine E is supplied with alternative fuel that improves the efficiency at which fuel is burned and consumed.

In an embodiment where engine E is a gasoline-powered engine, optional safety bubbler 12 may be provided to prevent flashback from the engine. This component is not needed in most embodiments in which engine E is a diesel-powered engine.

As the fresh air intake valve of engine E opens, pressurized gas (HHO alternative fuel) from pressure tank 8 starts filling the cylinder of engine E along with fresh air from the air filter. Gasoline or diesel fuel is also provided to the cylinder, although the addition of the HHO alternative fuel means that some amount of gasoline or diesel fuel is replaced by the HHO alternative fuel; that is, less gasoline or diesel fuel is provided to the cylinder than would normally be provided. The hydrogen provided to the cylinder (in the HHO alternative fuel) promotes a complete burn of all of the fuel in the combustion chamber, and the oxygen provided to the cylinder (in the HHO alternative fuel) promotes combustion and gives the fuel a higher octane rating, which increases fuel power. As a result, higher output power is obtained from the engine with less gasoline or diesel fuel being used.

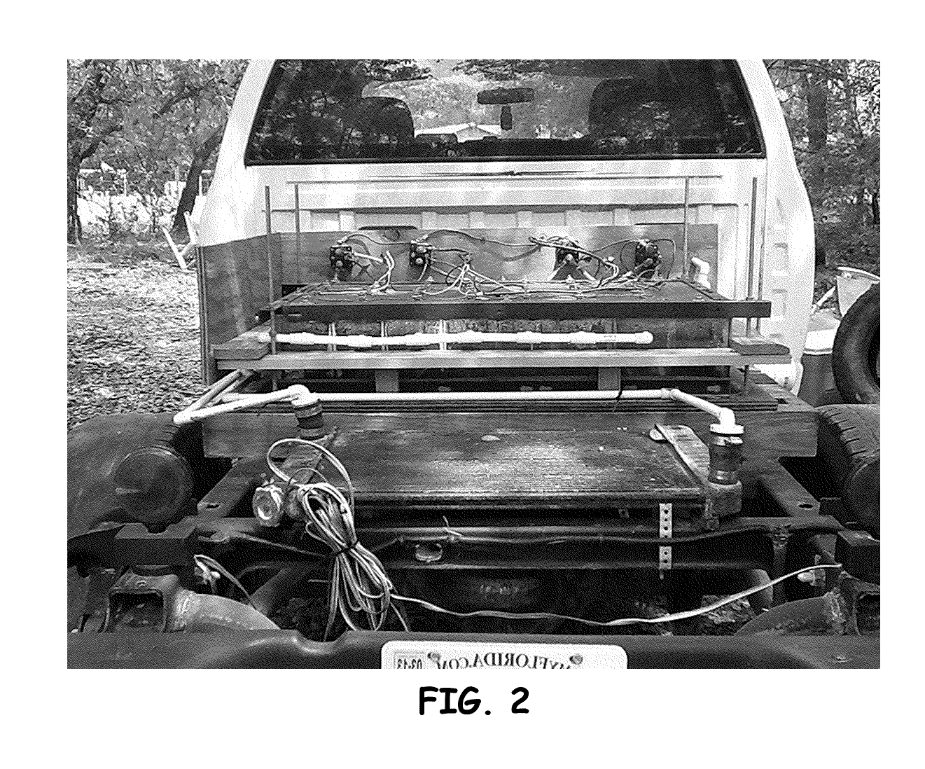

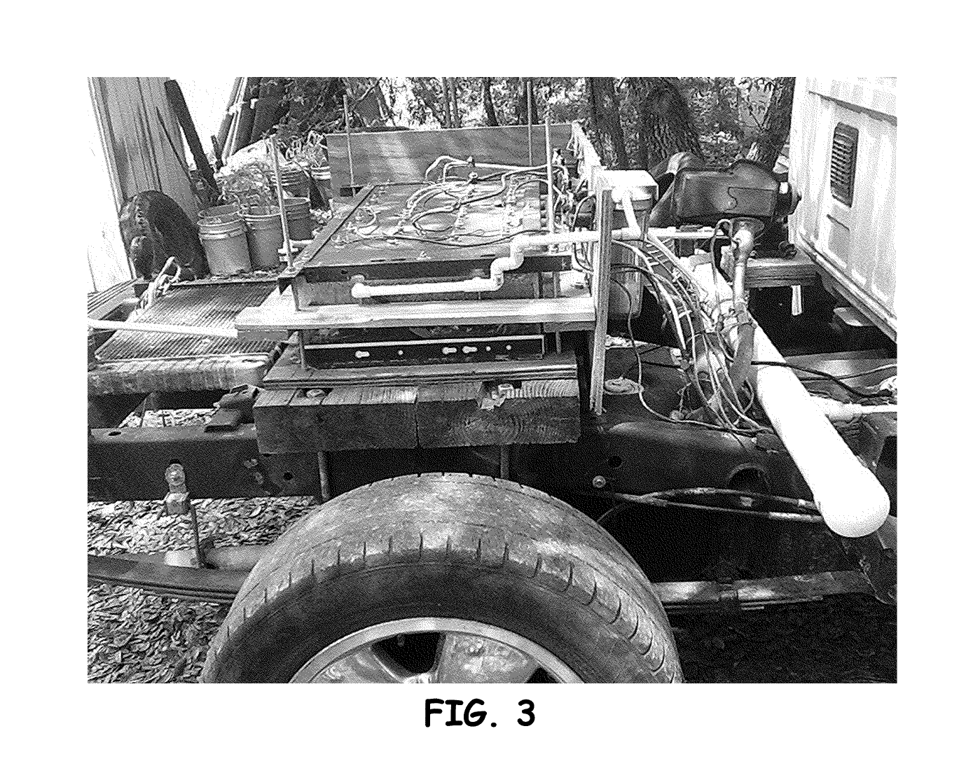

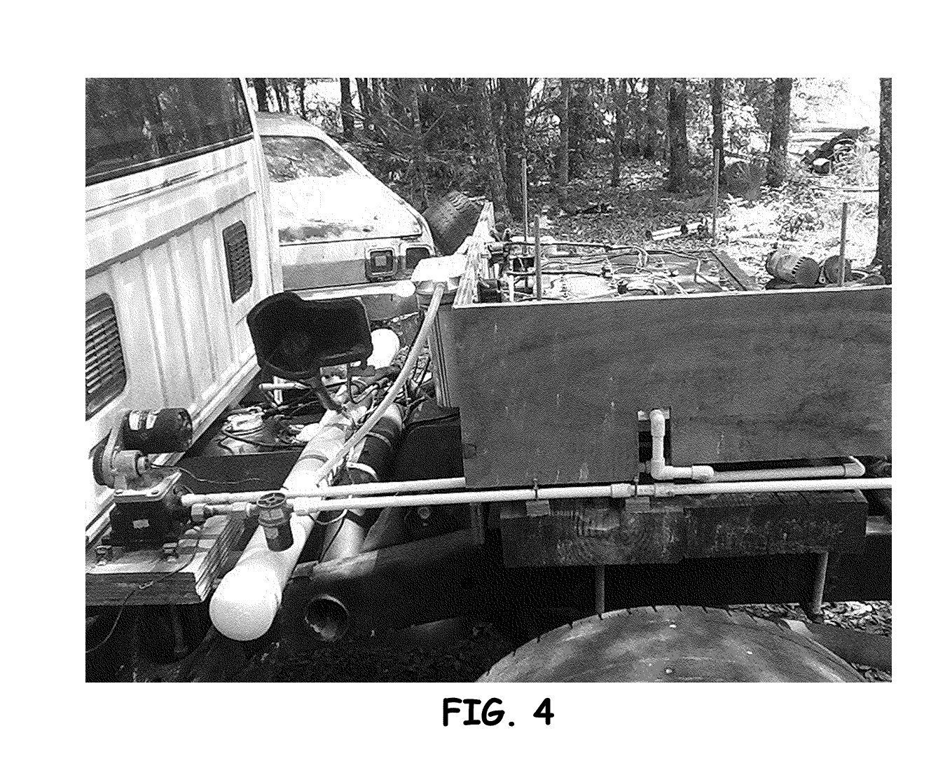

FIGS. 2, 3 and 4 are photographs of a prototype of a system that produces an HHO mix of fuel in vehicles that reduces exhaust emission and increases fuel efficiency, installed on a vehicle according to an embodiment of the present invention. The prototype shown in FIGS. 2, 3 and 4 was found to be capable of improving fuel efficiency of the vehicle by 25-50%. Road testing of the prototype shown in FIGS. 2, 3 and 4 was done under various driving conditions and times, and the routes varied from urban to country roads to state and federal highways. The physical components of the prototype include the components shown in FIG. 1A and described above, including power supply 1, HHO generator 2, liquid solution container and pump module 3, radiator/fan assembly 4, one-way valve 5, safety bubbler 6, dryer 7, pressure tank 8 with a cut-off switch, metering carburetor device 9, one-way valve 10, and shut-off solenoid 11. The components are assembled together and are not all visible in FIGS. 2, 3 and 4, but they are functionally connected as described above with respect to FIG. 1A.

FIGS. 5A (exploded view), 5B (inlet side view) and 5C (outlet side view) are diagrams illustrating an exemplary embodiment of an HHO generating structure for HHO generator 2 used in system S shown in FIGS. 1A and 1B. The HHO generating structure, as shown in FIGS. 5A-5C, includes polycarbonate end plates 30a and 30b and a plurality of grade 316L stainless steel plates 32 therebetween, separated by rubber gaskets 34. Alternating plates 32 are rotated 180 degrees from each other. The structure is held together by bolts 36 extending through apertures in end plates 30a and 30b and plates 32, fastened by washers 38 and nuts 40. In an exemplary embodiment, seven stainless steel plates 32 are used, although this number may be higher or lower in other embodiments. Stainless steel plates 32 are charged with current, for example with 120 Watts of power, so that molecules of water in the liquid solution passed through the HHO generator are broken apart into hydrogen and oxygen via electrolysis.

Multiple HHO generating structures may be used to provide the function of HHO generator 2. A single HHO generating structure is shown in FIGS. 5A-5C, but it should be understood that a plurality of HHO generating structures may be employed in exemplary embodiments to produce greater volumes of HHO gas. In an example system, each HHO generating structure may be capable of producing about 1 liter of HHO gas per minute.

FIG. 6 is a diagram illustrating an exemplary embodiment of carburetor device 9 (and one-way valve 10) for use in system S shown in FIGS. 1A and 1B. As shown in FIG. 6, carburetor device 9 includes input 50, throttle control valve 52 and flow control valve 54, and is connected at its output to one-way valve 10. In an exemplary embodiment, throttle control valve 52 is a solenoid valve that receives a control signal related to the throttle of the engine E, and flow control valve 54 is a needle valve. HHO gas from pressure tank 8 enters carburetor device 9 at input 50. If the engine is in an idle condition, throttle control valve 52 is controlled to be closed, and flow control valve 54 is configured to control the flow of HHO to the engine E at an idle rate, such as about 0.75-1.0 liters per minute in an exemplary embodiment The flow restriction provided by flow control valve is configured to cause pressure tank 8 to fill with gas at a fixed pressure, such as about 15 pounds per square inch (psi) (102 kilopascals (kPa)) in an exemplary embodiment. System S will cycle on and off to maintain pressure tank filed at this fixed pressure as long as the engine is in the idle condition. If the engine is accelerated, throttle control valve opens, and HHO gas flow from pressure tank 8 through carburetor system increases to a higher flow rate, such as a rate that provides about 0.25-0.5 liters per minute of HHO for every liter of displacement of the engine E (up to a limit of a rate of production of HHO by HHO generator 2, which may be increased in some embodiments by employing a higher number of HHO generating structures as shown in FIGS. 5A-5C).

By installing the system S that produces an HHO mix of fuel in vehicles that reduces exhaust emission and increases fuel efficiency shown in FIGS. 1A and 1B in line with the fresh air intake of a vehicle, the burning of fossil fuel in the engine E of the vehicle is enhanced. With the enhancement of the burning process, waste of fossil fuel is reduced (fuel that is typically left unburned is completely burned, thus used for propulsion). The invention improves the miles per gallon of diesel- and gasoline-powered vehicles, which saves money, improves the environment and reduce dependence upon foreign oil imports. The invention produces an HHO mix of alternative fuel that is two parts hydrogen and one part oxygen, which results in reduced exhaust emission. Approximately 70 percent of the fuel used in existing vehicles is wasted through heat or exhaust emission. The introduction of hydrogen enables the invention to reclaim a certain amount of that waste and utilize it in the propulsion of the vehicle. This increase of fuel efficiency results in a substantial increase in fuel mileage as well as an increase in vehicle horsepower.

System S employs a storage tank and a metering carburetor device for the HHO on-demand system, to provide a continuous, controlled flow of HHO gas to engine E. In many embodiments, the control of the HHO gas flow can be an important factor in achieving fuel efficiency improvement.

Adding hydrogen allows the engine to run in a leaner fuel/air condition. Without adding hydrogen, the stoichiometric ratio of fuel/air is 1 to 14.7 by mass. With hydrogen added, the engine can run at a fuel/air ratio of 1 to 20 or more. The presence of hydrogen acts much like a rectifier or reformer in that it helps the heavy fuel molecules to burn more completely than without hydrogen. The small amount of hydrogen inserted into the engine puts the otherwise unburned fuel into use, thus shifting the conventional fuel/air stoichiometry to a leaner condition.

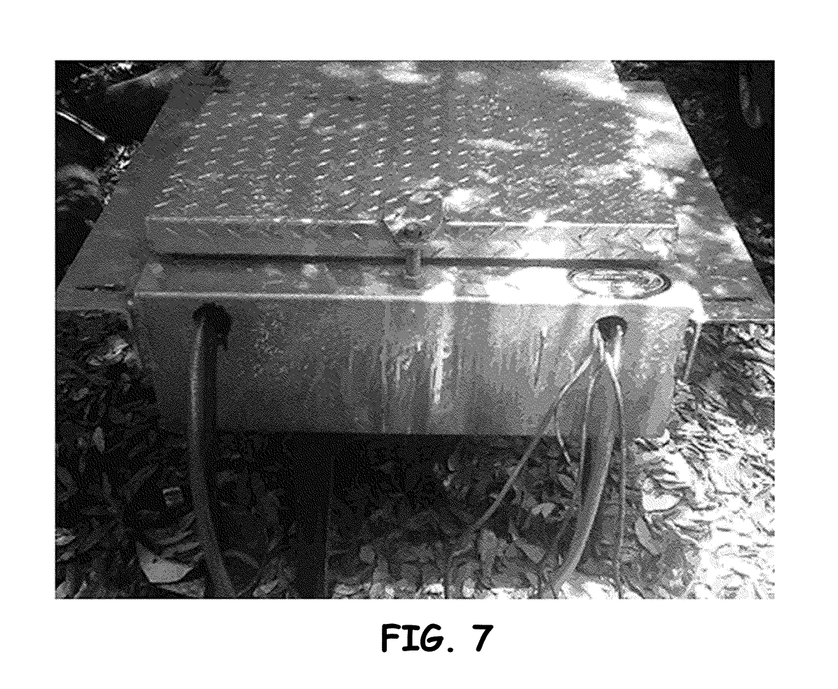

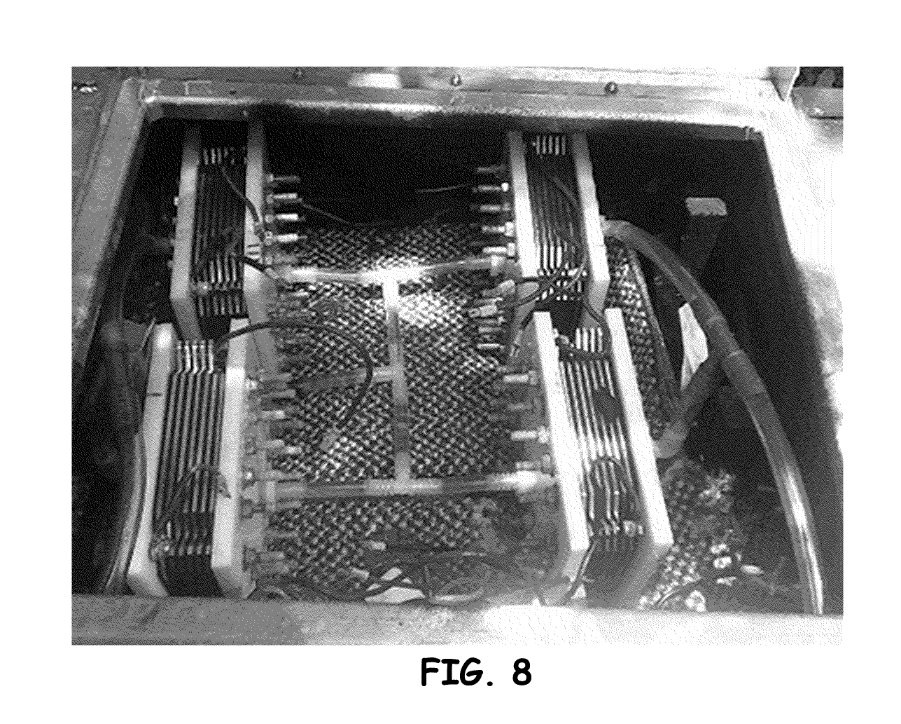

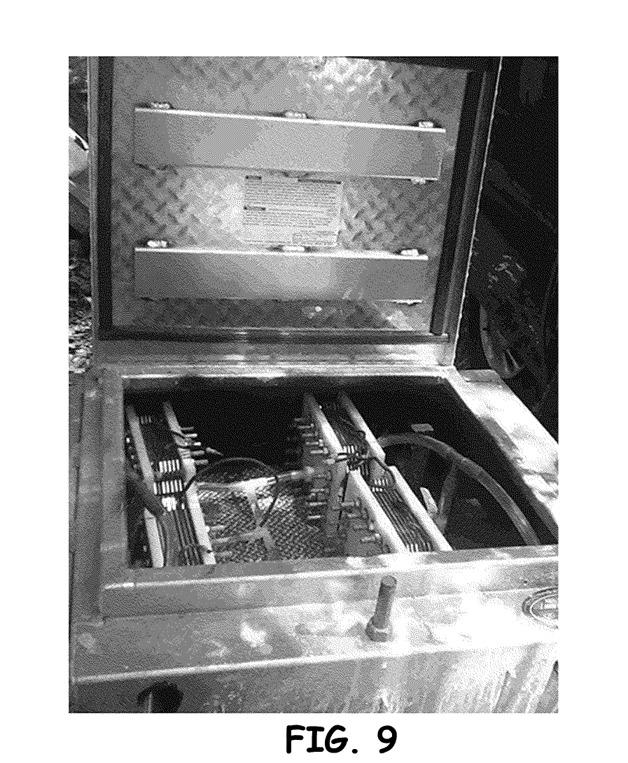

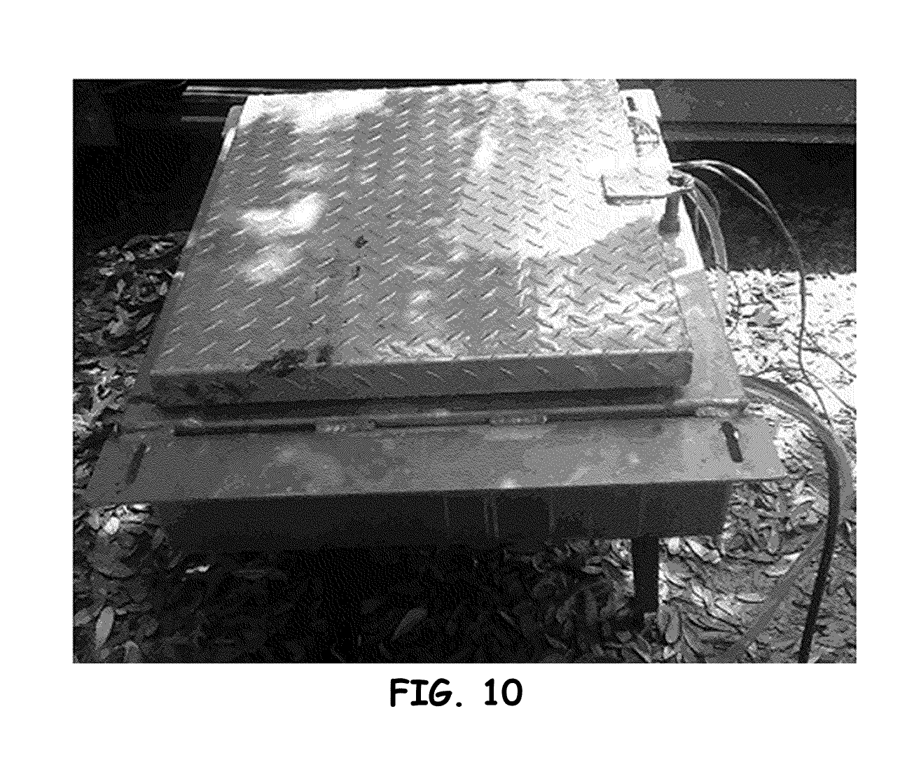

FIGS. 7, 8, 9 and 10 are photographs of a prototype of a system as shown in FIGS. 1A and 1B employing an HHO generator as shown in FIGS. 5A-5C and a carburetor device as shown in FIG. 6. The prototype system shown in FIGS. 7, 8, 9 and 10 was installed and tested as described below.

### Example Data

Testing of the system described herein was performed with a diesel semi tractor and trailer, where a prototype was installed and measurements were taken during road tests over a period of six months covering nearly 15,000 miles. The vehicle used was a 1990 Peterbilt tractor and 53 foot trailer. The tractor had a 335 horsepower caterpillar motor and 9 speed transmission In a first trial (Trial 1), three HHO generating structures were used, and a copper heat exchanger was used (which was damaged by potassium hydroxide solution and developed a leak). In a second trial (Trial 2), four HHO generating structures were used, and a stainless steel heat exchanger was used. The performance of the system was as follows:

| | | Fuel used | | |
|---|---|---|---|---|
| | Miles Driven | (gallons) | Miles per gallon | Improvement |
| Before | 6,496 | 1,418.34 | 4.58 | N/A |
| installation | | | | |
| Trial 1 | 5,280 | 953.58 | 5.537 | 20.9% |
| Trial 2 | 1,310 | 204.17 | 6.416 | 39.7% |

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A system for providing HHO gas to an internal combustion engine in a vehicle, comprising:
a power supply;
an HHO generator, powered by the power supply, comprising at least one HHO generating structure, arranged to receive a liquid electrolyte solution and output HHO gas;
a liquid solution container module coupled to the HHO generator, configured to hold and pump the liquid electrolyte solution and to separate the HHO gas from residual liquid electrolyte solution output from the HHO generator;
a dryer coupled to receive the HHO gas from the liquid solution container and gas separation module to remove moisture and/or particles in the HHO gas;
a pressure tank coupled to receive the HHO gas from the dryer and store a quantity of the HHO gas at a pressure level exceeding an ambient atmospheric pressure; and
a carburetor device coupled to the pressure tank, the carburetor device being operable to regulate a rate at which the HHO gas from the pressure tank flows to the internal combustion engine.

2. The system of claim 1, further comprising:
a radiator assembly coupled between the liquid solution container and gas separation module and the HHO generator for selectively cooling the liquid electrolyte solution prior to the liquid electrolyte solution being passed to the HHO generator;

3. The system of claim 2, wherein the radiator assembly is operable to cool the liquid electrolyte solution below 95° F.

4. The system of claim 1, wherein the power supply comprises a pulse width regulator.

5. The system of claim 1, wherein the HHO generator comprises a plurality of charged stainless steel plates configured to break chemical bonds of water in the liquid electrolyte solution to form the HHO gas.

6. The system of claim 1, wherein the liquid electrolyte solution is made up of 75% water and 25% potassium hydroxide (KOH) by volume.

7. The system of claim 1, wherein the pressure tank includes a cut-off switch configured to automatically shut off a flow of HHO gas when a pressure threshold is reached.

8. The system of claim 7, wherein the pressure threshold is about 15 pounds per square inch (psi).

9. The system of claim 1, wherein the carburetor device comprises a flow control valve configured to control the rate at which the HHO gas from the pressure tank flows to the internal combustion engine in an engine idle condition, and a throttle control valve configured to increase the rate at which the HHO gas from the pressure tank flows to the internal combustion engine in response to acceleration of the internal combustion engine.

10. The system of claim 9, wherein the rate at which the HHO gas from the pressure tank flows to the internal combustion engine in the engine idle condition is about 0.75-1.0 liters per minute.

11. The system of claim 9, wherein the rate at which the HHO gas from the pressure tank flows to the internal combustion engine in response to acceleration of the internal combustion engine is about 0.25-0.5 liters per minute of HHO gas for every liter of displacement of the internal combustion engine.

12. A method of providing HHO gas to an internal combustion engine in a vehicle, the method comprising:
providing a liquid electrolyte solution to an HHO generator configured to produce and output HHO gas therefrom;
separating residual electrolyte solution from the HHO gas output by the HHO generator;
storing a quantity of the HHO gas in a pressure tank at a pressure level exceeding an ambient atmospheric pressure; and
regulating a rate at which the HHO gas from the pressure tank flows to the internal combustion engine with a carburetor device.

13. The method of claim 12, further comprising selectively cooling the liquid electrolyte solution prior to the liquid electrolyte solution being provided to the HHO generator.

14. The method of claim 13, wherein selectively cooling the liquid electrolyte solution comprises cooling the liquid electrolyte solution below 95° F.

15. The method of claim 12, wherein storing a quantity of the HHO gas in the pressure tank at the pressure level exceeding the ambient atmospheric pressure comprises automatically shutting off a flow of the HHO gas to the pressure tank when the pressure level is reached.

16. The method of claim 15, wherein the pressure level is about 15 pounds per square inch (psi).

17. The method of claim 12, wherein regulating the rate at which the HHO gas from the pressure tank flows to the internal combustion engine with the carburetor device comprises operating a flow control valve to control the rate at which the HHO gas from the pressure tank flows to the internal combustion engine in an engine idle condition, and operating a throttle control valve to increase the rate at which the HHO gas from the pressure tank flows to the internal combustion engine in response to acceleration of the internal combustion engine.

18. The method of claim 17, wherein the rate at which the HHO gas from the pressure tank flows to the internal combustion engine in the engine idle condition is about 0.75-1.0 liters per minute.

19. The method of claim 17, wherein the rate at which the HHO gas from the pressure tank flows to the internal combustion engine in response to acceleration of the internal combustion engine is about 0.25-0.5 liters per minute of HHO gas for every liter of displacement of the internal combustion engine.
